(19) United States
(12) Patent Application Publication
(10) Pub. No.: US 2023/0135844 A1
(43) Pub. Date: May 4, 2023

(54) SOFTWARE EVALUATION APPARATUS, SOFTWARE EVALUATION METHOD, AND COMPUTER-READABLE MEDIUM

(71) Applicant: NEC Corporation, Minato-ku, Tokyo (JP)

(72) Inventor: Yuki MIYAGUCHI, Tokyo (JP)

(73) Assignee: NEC Corporation, Minato-ku, Tokyo (JP)

(21) Appl. No.: 17/910,290

(22) PCT Filed: Mar. 24, 2020
(86) PCT No.: PCT/JP2020/013058

§ 371 Date: Sep. 8, 2022

(51) Int. Cl. G06F 8/77; G06F 8/36

(52) U.S. Cl. CPC G06F 8/77; G06F 8/36

(57) ABSTRACT

Provided is a software evaluation apparatus capable of appropriately evaluating a tendency of reliability of software. An information acquisition unit (2) acquires software information that is information related to software used in an application, the software enabling a plurality of users to view, use, and modify a source code. A recommended value calculation unit (4) calculates, from the software information, a software recommended value which is a degree of reliability related to the software. A tendency analysis unit (6) analyzes a tendency related to the software based on a change in the software recommended value.

### TECHNICAL FIELD

The present invention relates to a software evaluation apparatus, a software evaluation method, and a computer-readable medium.

### BACKGROUND ART

At the time of development of an application, software such as open source software (OSS) may be utilized that can access, use, and modify a source code. Regarding such a technique, Patent Literature 1 discloses a development support method for selecting a more appropriate OSS in selection of an OSS to be used. The method according to Patent Literature 1 includes: detecting a use candidate software source which is a candidate of a software source to be used for a development product; and outputting a score indicating a degree of adaptation of the use candidate software source to each of selection conditions indicated by a policy corresponding to the development product. The method according to Patent Literature 1 includes outputting information on the use candidate software source including an updated score obtained by adding a weight to the score, based on information indicating a configuration of an existing development product including an arbitrary part of the use candidate software source.

### CITATION LIST

### Patent Literature

Patent Literature 1: Japanese Unexamined Patent Application Publication No. 2015-161982

### SUMMARY OF INVENTION

### Technical Problem

Since an unspecified number of developers have developed software such as an OSS that can access, use, and modify a source code, it is difficult to guarantee the quality of such software. Then, there is a risk that reliability of the adopted software will decrease after an application realized by a combination of some of such software is put into actual operation. However, even when such a risk occurs, it is difficult to detect the occurrence of the risk. Here, Patent Literature 1 does not disclose detection of a tendency of reliability in the OSS. Therefore, the technique according to Patent Literature 1 cannot evaluate the risk of deterioration of the reliability of the OSS.

An object of the present disclosure is to solve such a problem, and to provide a software evaluation apparatus, a software evaluation method, and a program capable of appropriately evaluating a tendency of reliability in software.

### Solution to Problem

A software evaluation apparatus according to the present disclosure includes: information acquisition means for acquiring software information that is information related to software used in an application, the software enabling a plurality of users to view, use, and modify a source code; recommended value calculation means for calculating, from the software information, a software recommended value which is a degree of reliability related to the software; and tendency analysis means for analyzing a tendency related to the software based on a change in the software recommended value.

Further, a software evaluation method according to the present disclosure includes: acquiring software information that is information related to software used in an application, the software enabling a plurality of users to view, use, and modify a source code; calculating, from the software information, a software recommended value which is a degree of reliability related to the software; and analyzing a tendency related to the software based on a change in the software recommended value.

Further, a program according to the present disclosure causes a computer to execute: a step of acquiring software information that is information related to software used in an application, the software enabling a plurality of users to view, use, and modify a source code; a step of calculating, from the software information, a software recommended value which is a degree of reliability related to the software; and a step of analyzing a tendency related to the software based on a change in the software recommended value.

### Advantageous Effects of Invention

According to the present disclosure, it is possible to provide a software evaluation apparatus, a software evaluation method, and a program capable of appropriately evaluating a tendency of reliability in software.

### BRIEF DESCRIPTION OF DRAWINGS

FIG. 1 is a diagram showing an outline of a software evaluation apparatus according to an example embodiment of the present disclosure;

FIG. 2 is a flowchart showing a software evaluation method to be executed by the software evaluation apparatus according to an example embodiment of the present disclosure;

FIG. 3 is a diagram showing a configuration of a software evaluation system according to a first example embodiment;

FIG. 4 is a diagram showing a configuration of a software evaluation apparatus according to the first example embodiment;

FIG. 5 is a diagram illustrating a use software information table stored in a use software information DB according to the first example embodiment;

FIG. 6 is a diagram illustrating a function information table stored in a function information DB according to the first example embodiment;

FIG. 7 is a diagram illustrating a website management table stored in a website management DB according to the first example embodiment;

FIG. 8 is a diagram illustrating a website-specific recommendation level table stored in a recommendation level management DB according to the first example embodiment;

FIG. 9 is a diagram illustrating a function-specific recommendation level table stored in the recommendation level management DB according to the first example embodiment;

FIG. 10 is a diagram illustrating an integrated recommendation level management table stored in the recommendation level management DB according to the first example embodiment;

FIG. 11 is a flowchart showing a software evaluation method to be executed by the software evaluation apparatus according to the first example embodiment;

FIG. 12 is a sequence diagram showing details of a process of S110 shown in FIG. 11;

FIG. 13 is a sequence diagram showing details of a process of S120 shown in FIG. 11;

FIG. 14 is a sequence diagram showing details of a process of S130 shown in FIG. 11;

FIG. 15 is a sequence diagram showing details of a process of S140 shown in FIG. 11;

FIG. 16 is a sequence diagram showing details of a process of S150 shown in FIG. 11;

FIG. 17 is a sequence diagram showing details of a process of S160 shown in FIG. 11;

FIG. 18 is a diagram illustrating a transition of a moving average value and a change amount of an integrated recommendation score according to the first example embodiment; and

FIG. 19 is a flowchart showing details of a process of a process of S170 shown in FIG. 11.

### EXAMPLE EMBODIMENT

(Outline of Example Embodiment according to Present Disclosure)

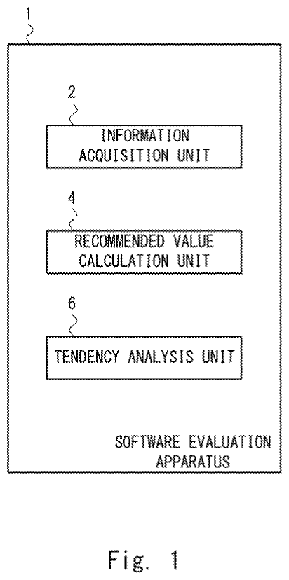

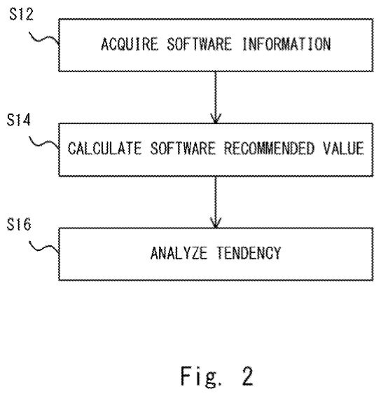

Prior to the description of an example embodiment of the present disclosure, an outline of the example embodiment of the present disclosure will be described. FIG. 1 is a diagram showing an outline of a software evaluation apparatus 1 according to the example embodiment of the present disclosure. Further, FIG. 2 is a flowchart showing a software evaluation method executed by the software evaluation apparatus 1 according to the example embodiment of the present disclosure.

The software evaluation apparatus 1 is a computer, for example. The software evaluation apparatus 1 includes an information acquisition unit 2, a recommended value calculation unit 4, and a tendency analysis unit 6. The information acquisition unit 2, the recommended value calculation unit 4, and the tendency analysis unit 6 have functions as information acquisition means, recommended value calculation means, and tendency analysis means, respectively.

The information acquisition unit 2 acquires software information (step S12). Here, the “software information” is information on software used for an application, the software capable of allowing a plurality of users to view (access), use, and modify a source code. Further, the “software capable of allowing the plurality of users to view (access), use, and modify the source code” is, for example, open source software (OSS), but is not limited thereto. The software according to the present example embodiment may be software capable of allowing “a plurality of users in a (closed) organization” to view, use, and modify the source code, for example. In other words, the software (source code) according to the present example embodiment does not need to be viewed by users all over the world, and may be viewable by a plurality of users of a limited organization.

The recommended value calculation unit 4 calculates a software recommended value from the acquired software information (step S14). Here, the software recommended value is a degree of reliability regarding software (OSS or the like). The tendency analysis unit 6 analyzes a tendency regarding software (OSS or the like) based on a change in the software recommended value (step S16). For example, the tendency analysis unit 6 may analyze a tendency of the presence or absence of a risk related to the software (OSS or the like) based on the change in the software recommended value and reference information (threshold value) indicating a reference for this change.

The software evaluation apparatus 1 according to the present example embodiment is configured to analyze the tendency related to the software (OSS or the like) based on the change in the software recommended value. Therefore, the software evaluation apparatus 1 according to the present example embodiment can appropriately evaluate the tendency of software reliability. Then, it is possible to provide the user with determination information for guaranteeing the quality of the application in actual operation. The tendency of software reliability can also be appropriately evaluated by the software evaluation method and a program executing the software evaluation method.

The information acquisition unit 2 may acquire function information as software information regarding a software function (S12). The function information will be described below. At this time, the recommended value calculation unit 4 may calculate a function recommendation score, which is an evaluation index for the function of the software used for the application, based on the function information, and calculate the software recommended value using the function recommendation score (S14). The function recommendation score will be described below. With such a constitution, it is possible to more accurately calculate a software recommended value suitable for the intended use for the application (application product) to be developed. Therefore, it is possible to more appropriately evaluate the tendency of software reliability.

In addition, the information acquisition unit 2 may acquire one or more recommendation levels for the software as software information. The recommendation level will be described below. At this time, the recommended value calculation unit 4 may calculate a software recommendation score, which is the evaluation index of the software, based on one or more recommendation level, and may calculate the software recommended value using the software recommendation score. The software recommendation score will be described below. Further, the recommended value calculation unit 4 may calculate the software recommendation score, and may calculate the software recommended value using the software recommendation score and the function recommendation score.

Further, the recommended value calculation unit 4 may calculate, as a software recommended value, an integrated recommendation score in which the software recommendation score and the function recommendation score are integrated. The integrated recommendation score will be described below. At this time, the tendency analysis unit 6 may analyze the tendency regarding the software based on the change in the integrated recommendation score. With such a constitution, it is possible to more accurately calculate the integrated recommendation score, which is a software recommended value, for the application to be developed. Therefore, it is possible to more appropriately evaluate the tendency of software reliability.

### First Example Embodiment

Hereinafter, an example embodiment will be described with reference to the drawings. The following description and drawings are omitted and simplified as appropriate to clarify the description. Further, in each of the drawings, the same components are denoted by the same reference numerals, and will not be described repeatedly.

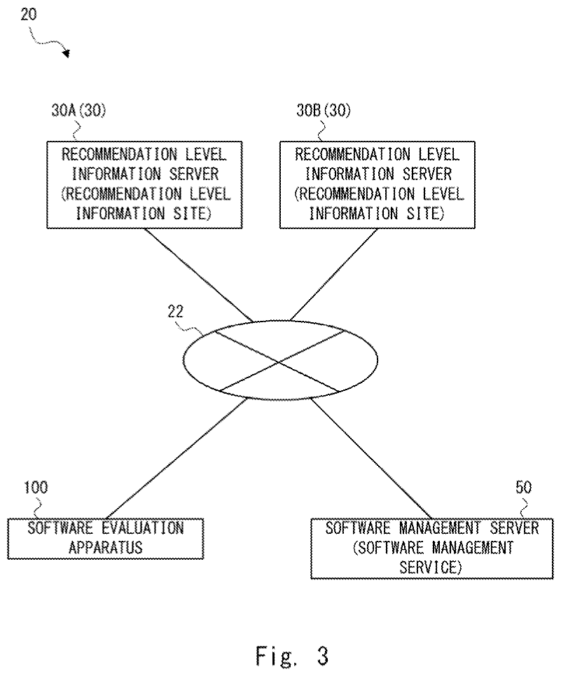

FIG. 3 is a diagram showing a constitution of a software evaluation system 20 according to the first example embodiment. The software evaluation system 20 includes one or more recommendation level information servers 30 (30A, 30B), a software management server 50, and a software evaluation apparatus 100. The recommendation level information server 30, the software management server 50, and the software evaluation apparatus 100 can be communicably connected to each other via a network 22 such as the Internet. The recommendation level information server 30, the software management server 50, and the software evaluation apparatus 100 may be implemented by cloud computing, for example. In this case, the recommendation level information server 30, the software management server 50, and the software evaluation apparatus 100 do not need to be physically separated from each other.

The recommendation level information server 30 implements a website (recommendation level information site) that provides information (recommendation level information) regarding the recommendation level of software (hereinafter, simply referred to as software) such as OSS. The recommendation level information server 30 provides a recommendation level for each software. The recommendation level information server 30 is, for example, Open Hub (registered trademark), OSS Radar Scope (registered trademark), or a server that provides an OSS recommendation level site in a (closed) organization, but is not limited thereto. The recommendation level information server 30 can provide the recommendation level information to users all over the world or to a plurality of users in a limited organization. An index indicating the recommendation level of the software may differ for each of the plurality of recommendation level information servers 30 (recommendation level information sites). Although two recommendation level information servers 30A and 30B are shown in FIG. 3, the number of recommendation level information servers 30 is arbitrary.

The software management server 50 provides a service (software management service) that manages a source code of software (program). The software management server 50 can implement a version control system that records and tracks change history of a source code, and the like. The software management server 50 (software management service) opens the source code of the software to a plurality of user, and provides a service for enabling the plurality of users to view, use, and modify the source code. In other words, the plurality of users can use the software management service to view, use, modify, and preserve the source code. Then, software development can be promoted by unspecified number of developers who edit the source code registered and opened in the software management service. The software management server 50 is, for example, GitHub (registered trademark), but is not limited thereto. The software management server 50 can provide the software management service to users all over the world or to a plurality of users in a limited organization. Although one software management server 50 is shown in FIG. 3, the number of software management servers 50 is arbitrary.

The software management server 50 registers function information regarding a function of each software. The function information indicates information regarding a source file. Here, the software is configured by a plurality of source files. Then, each source file is a module that implements a function of software set in advance. The function information can include code information and change information. The code information indicates a source code of each software (source file). Further, the change information indicates change history and the number of changes (number of times of change) of the source file (source code) constituting each software. The change information is, for example, commit information, but is not limited thereto.

The software evaluation apparatus 100 corresponds to the software evaluation apparatus 1 shown in FIG. 1. The software evaluation apparatus 100 evaluates reliability of software such as OSS. In the following example, the software evaluation apparatus 100 will be described as evaluating the reliability of the OSS.

The software evaluation apparatus 100 acquires software information regarding software such as OSS. Here, the “software information” can include the recommendation level information and the function information. Further, the software evaluation apparatus 100 calculates a software recommended value which is a degree of reliability regarding software. Then, the software evaluation apparatus 100 analyzes the tendency regarding the software based on the change in the software recommended value. Details will be described below.

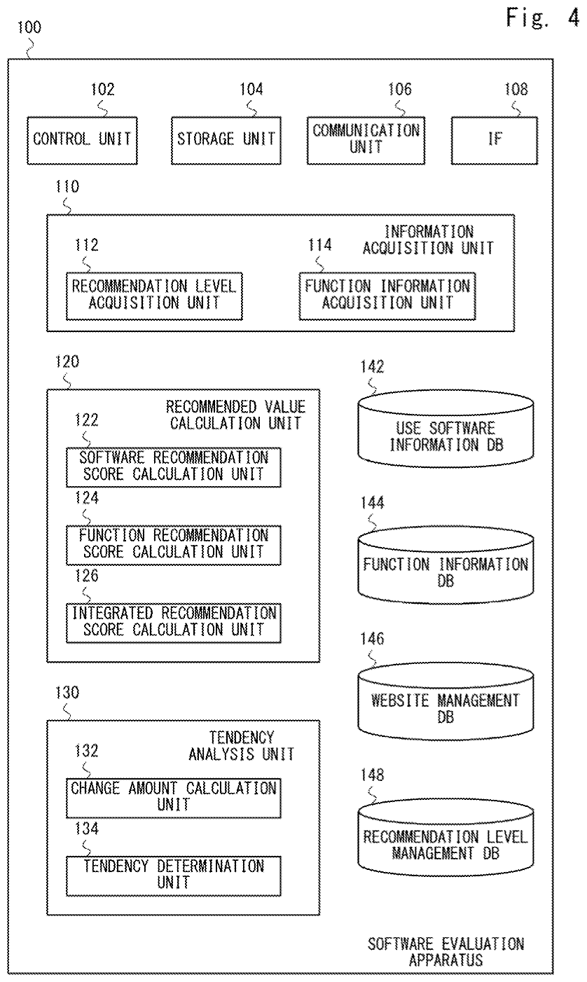

FIG. 4 is a diagram showing a constitution of the software evaluation apparatus 100 according to the first example embodiment. The software evaluation apparatus 100 includes, as main hardware components, a control unit 102, a storage unit 104, a communication unit 106, and an IF unit 108 (IF: Interface). The control unit 102, the storage unit 104, the communication unit 106, and the interface unit 108 are connected to each other via a data bus and the like.

The control unit 102 is a processor such as a CPU (Central Processing Unit). The control unit 102 has a function as an arithmetic unit that performs control processing and arithmetic processing. The storage unit 104 is a storage device such as a memory or a hard disk. The storage unit 104 is, for example, a ROM (Read Only Memory) or a RAM (Random Access Memory). The storage unit 104 has a function for storing a control program and an arithmetic program and the like executed by the control unit 102. Further, the storage unit 104 has a function for temporarily storing processed data and the like. The storage unit 104 may include a database.

The communication unit 106 performs processing necessary for communicating with other apparatuses of the recommendation level information server 30 and the software management server 50 and the like via the network 22.

The communication unit 106 may include a communication port, a router, a firewall, and the like. The interface unit 108 is a user interface (UI), for example. The interface unit 108 includes an input apparatus such as a keyboard, a touch screen, or a mouse and an output apparatus such as a display or a speaker. The interface unit 108 receives an operation of inputting data performed by a user (operator) and outputs information to the user. The interface unit 108 may display results of tendency analysis.

The software evaluation apparatus 100 according to the first example embodiment includes, as components, an information acquisition unit 110, a recommended value calculation unit 120, a tendency analysis unit 130, and various DBs (DB: database). Further, the software evaluation apparatus 100 according to the first example embodiment includes, as components of the database, a use software information DB 142, a function information DB 144, a website management DB 146, and a recommendation level management DB 148.

The information acquisition unit 110 includes a recommendation level acquisition unit 112 and a function information acquisition unit 114. The recommended value calculation unit 120 includes a software recommendation score calculation unit 122, a function recommendation score calculation unit 124, and an integrated recommendation score calculation unit 126. The tendency analysis unit 130 includes a change amount calculation unit 132 and a tendency determination unit 134. The software evaluation apparatus 100 does not need to be physically configured by one apparatuses. In this case, the above-described components may be implemented by a plurality of physically separate apparatuses. For example, the various DBs are configured by another apparatus.

The information acquisition unit 110 corresponds to the information acquisition unit 2 shown in FIG. 1. The information acquisition unit 110 has a function as information acquisition means. The recommended value calculation unit 120 corresponds to the recommended value calculation unit 4 shown in FIG. 1. The recommended value calculation unit 120 has a function as recommended value calculation means. The tendency analysis unit 130 corresponds to the tendency analysis unit 6 shown in FIG. 1. The tendency analysis unit 130 has a function as tendency analysis means.

Further, the recommendation level acquisition unit 112 has a function as recommendation level acquisition means. The function information acquisition unit 114 has a function as function information acquisition means. The software recommendation score calculation unit 122 has a function as software recommendation score calculation means. The function recommendation score calculation unit 124 has a function as function recommendation score calculation means. The integrated recommendation score calculation unit 126 has a function as integrated recommendation score calculation means. The change amount calculation unit 132 has a function as change amount calculation means. The tendency determination unit 134 has a function as tendency determination means.

In addition, the use software information DB 142 has a function as use software information storage means. The function information DB 144 has a function as function information storage means. The website management DB 146 has a function as website management information storage means. The recommendation level management DB 148 has a function as recommendation level management information storage means.

The above-described components can be implemented by executing a program under control of the control unit 102, for example. More specifically, the components can be implemented when the program stored in the storage unit 104 is executed by the control unit 102. Further, when a necessary program is recorded on an arbitrary non-volatile recording medium and is installed as needed, the components can be implemented. In addition, the components is not limited to being implemented by a software program, and may be implemented by any combination of hardware, firmware, and software. Further, the components may be implemented using a user-programmable integrated circuit such as a FPGA (field-programmable gate array) or a microcomputer. In this case, a program configured by the above-described components may be implemented using such an integrated circuit. A detailed function of each of the components will be described below.

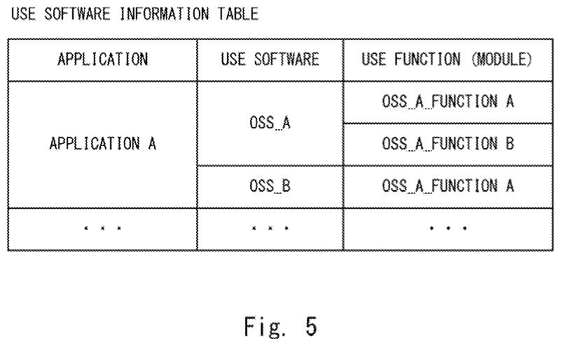

FIG. 5 is a diagram illustrating a use software information table stored in the use software information DB 142 according to the first example embodiment. The use software information table indicates information on software (use software) used for the application to be developed. The use software information table includes each application, and use software and use function (use module) related to each application. The use function indicates a function (module; source file) used in the application to be developed in the use software. The use software information table illustrated in FIG. 5 can be generated by processing to be described below.

In the example shown in FIG. 5, software used in an “application A” to be developed are “OSS_A” and “OSS_B”. In the “OSS_A”, functions (modules) used in the “application A” are “OSS_A function A” and “OSS_A function B”. In the “OSS_B”, a function (module) used in the “application A” is “OSS_B function A”.

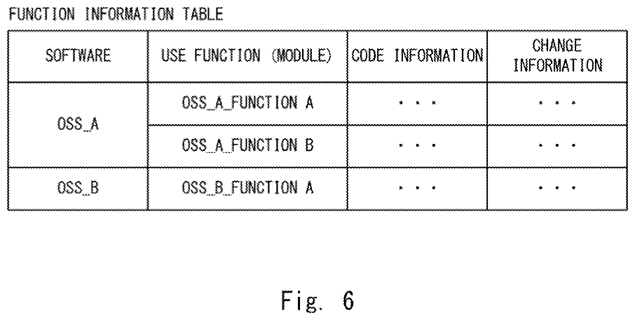

FIG. 6 is a diagram illustrating a function information table stored in the function information DB 144 according to the first example embodiment. The function information table includes each software, a use function (module; source file) related to each software, and code information and change information related to the use function. The function information table illustrated in FIG. 6 can be generated by processing to be described below.

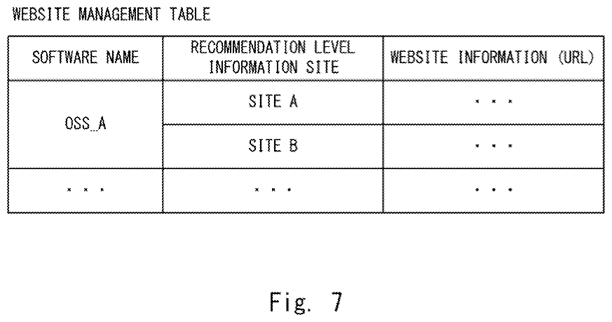

FIG. 7 is a diagram illustrating a website management table stored in the website management DB 146 according to the first example embodiment. The website management table includes identification information (software name) of each software, recommendation level information site (identification information of recommendation level information site) related to the software, and website information related to each recommendation level information site. The recommendation level information site is a website where a recommendation level for the corresponding software is published. In the example shown in FIG. 7, a recommendation level of “OSS_A” is provided (published) by a “site A” realized by the recommendation level information server 30A and a “site B” realized by the recommendation level information server 30B. The website information is, for example, a URL (Uniform Resource Locator) for accessing the corresponding recommendation level information site. The website management table illustrated in FIG. 7 may be created in advance by an administrator.

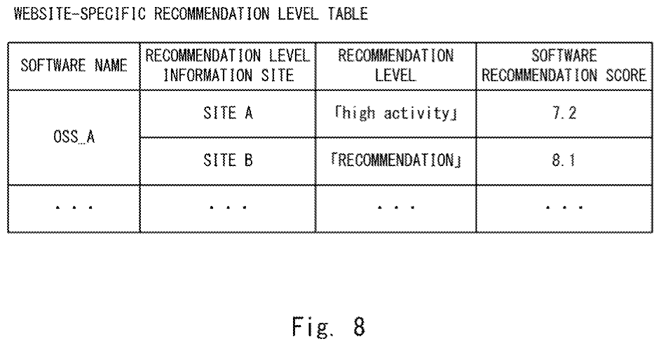

FIG. 8 is a diagram illustrating a website-specific recommendation level table stored in the recommendation level management DB 148 according to the first example embodiment. The website-specific recommendation level table includes identification information (software name) of each software, a recommendation level information site (identification information of the recommendation level information site) related to the software, a recommendation level in each recommendation level information site, and a software recommendation score corresponding to the recommendation level. The website-specific recommendation level table illustrated in FIG. 8 can be generated by processing to be described below. A method of calculating the software recommendation score will be described below.

In the example shown in FIG. 8, a recommendation level of “OSS_A” is “high activity” in a “site A”, and is a “recommendation” in a “site B”. In this way, a scoring method (evaluation index) of the recommendation level differs depending on each recommendation level information site. On the other hand, the software recommendation score is a recommended value that is scored by a common evaluation index, as will be described below. In the example of FIG. 8, a software recommendation score corresponding to a recommendation level “high activity” of “OSS_A” in a “site A” is “7.2”. Further, a software recommendation score corresponding to a recommendation level “recommendation” of “OSS_A” in a “site B” is “8.1”. Therefore, reliability of “OSS_A” is higher at the “site B” than at the “site A”.

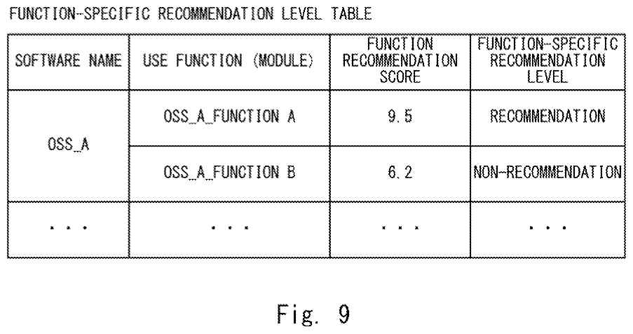

FIG. 9 is a diagram illustrating a function-specific recommendation level table stored in the recommendation level management DB 148 according to the first example embodiment. The function-specific recommendation level table includes identification information (software name) of each software, a use function (identification information of a use function) in each software, a function recommendation score which is an evaluation index for each use function, and a function-specific recommendation level which is a recommendation level for each function. The function-specific recommendation level indicates a “recommendation” when the function recommendation score is equal to or greater than a predetermined threshold value, and indicates “non-recommendation” when the function recommendation score is smaller than the predetermined threshold value. The function-specific recommendation level table can be generated by processing to be described below. A method of calculating the function recommendation score will be described below.

In the example shown in FIG. 9, a function recommendation score of “OSS_A function A” is “9.5”, and the function-specific recommendation level indicates “recommendation”. Further, a function recommendation score of “OSS_A function B” is “6.2”, and the function-specific recommendation level indicates “non-recommendation”. By the calculation of the function recommendation score in this way, the reliability can be evaluated for each function used in the application in the software.

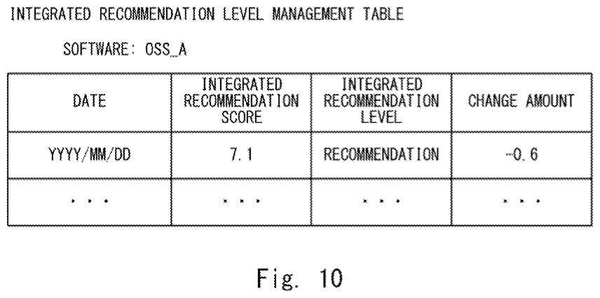

FIG. 10 is a diagram illustrating an integrated recommendation level management table stored in the recommendation level management DB 148 according to the first example embodiment. In the integrated recommendation level management table, an integrated recommendation score, an integrated recommendation level, and a change amount, on a certain date, are associated with each other for each software. Here, the integrated recommendation score is a recommended value (software recommended value) obtained by integration of the software recommendation score and the function recommendation score. The integrated recommendation score will be described below. Further, the integrated recommendation level indicates a “recommendation” when the integrated recommendation score is equal to or greater than a predetermined threshold value, and indicates a “non-recommendation” when the integrated recommendation score is smaller than the predetermined threshold value. The “change amount” is a value indicating a change in the integrated recommendation score until the corresponding date from the start of calculating the integrated recommendation score. The integrated recommendation level management table can be generated by processing to be described below. A method of calculating the integrated recommendation score and the change amount will be described below.

In the example shown in FIG. 10, with respect to for “OSS_A”, the integrated recommendation score is “7.1”, and the integrated recommendation level indicates a “recommendation”, on a certain date “YYYY/MM/DD”. Further, the change amount is “−0.6”. Here, in the example shown in FIG. 10, since the change amount is a negative value, it can be seen that the integrated recommendation score has reduced from a time point of start of the calculation of the integrated recommendation score.

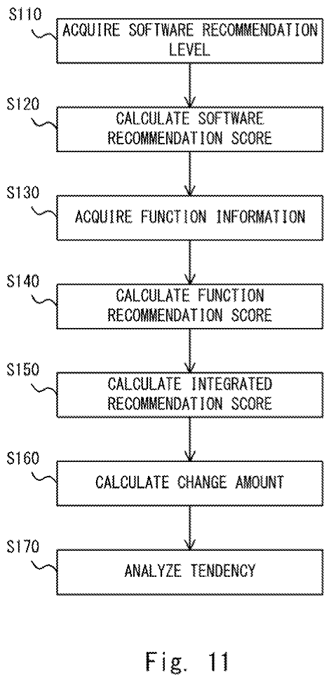

FIG. 11 is a flowchart showing a software evaluation method executed by the software evaluation apparatus 100 according to the first example embodiment. The information acquisition unit 110 acquires a recommendation level of software as software information (step S110). Specifically, the recommendation level acquisition unit 112 acquires, for the use software, a recommendation level published on one or more recommendation level information sites from the recommendation level information server 30 via the communication unit 106. Details will be described below.

The recommended value calculation unit 120 calculates a software recommendation score (step S120). Specifically, the software recommendation score calculation unit 122 calculates a software recommendation score, which is an evaluation index of the use software, using the recommendation level acquired in the process of S110. Details will be described below.

The information acquisition unit 110 acquires function information as software information (step S130). Specifically, the function information acquisition unit 114 acquires function information (code information and change information) related to the use function used in the application for the use software, from the software management server 50 via the communication unit 106. Details will be described below.

The recommended value calculation unit 120 calculates a function recommendation score (step S140). Specifically, the function recommendation score calculation unit 124 calculates a function recommendation score, which is an evaluation index related to the use function for the user software, using the function information acquired in the process of S130. Details will be described below.

The recommended value calculation unit 120 calculates an integrated recommendation score (step S150). Specifically, the integrated recommendation score calculation unit 126 calculates, for the use software, an integrated recommendation score obtained by integration of the software recommendation score and the function recommendation score as software recommended values. Details will be described below.

The tendency analysis unit 130 calculates a change amount (step S160). Specifically, the change amount calculation unit 132 calculates a change amount of the integrated recommendation score for the use software. Details will be described below. Then, the tendency analysis unit 130 analyzes a tendency related to the use software (step S170). Specifically, the tendency determination unit 134 analyzes a tendency related to the use software based on the change in the integrated recommendation score (software recommended value). More specifically, the tendency determination unit 134 analyzes a tendency of the presence or absence of a risk occurrence related to the use software, based on the change in the integrated recommendation score (software recommended value) and reference information (attention-required tendency value) indicating a reference for this change. Details will be described below.

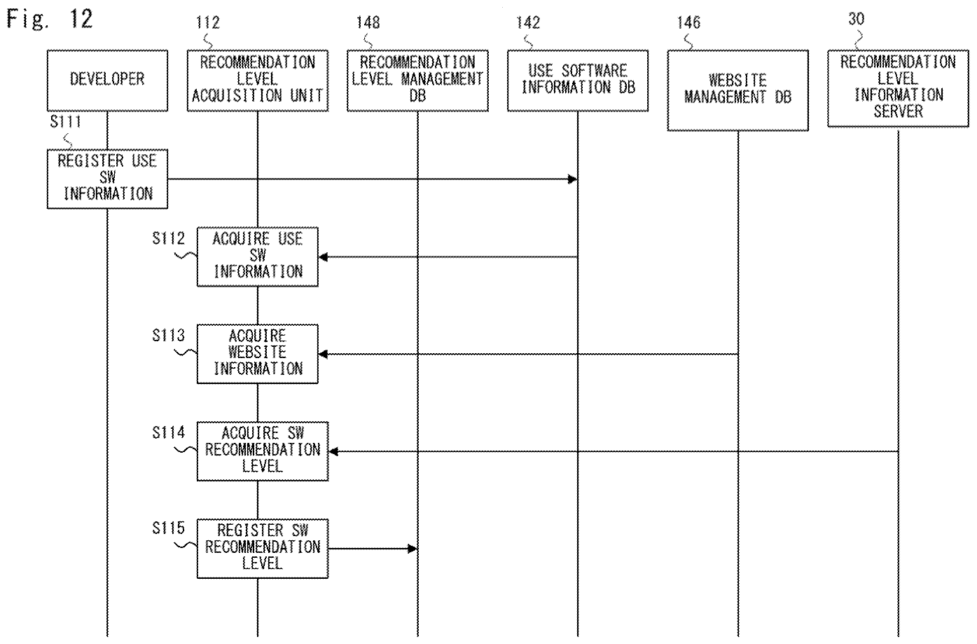

FIG. 12 is a sequence diagram showing details of the process of S110 shown in FIG. 11. A developer registers the use software information indicating a list of the use software, which is used in the application, in the use software information DB 142 (step S111). Thus, the items of “application” and “use software” in the use software information table illustrated in FIG. 5 are generated. Then, the recommendation level acquisition unit 112 acquires use software information indicating the list of the use software from the use software information DB 142 (step S112).

The recommendation level acquisition unit 112 acquires website information of the recommendation level information site for which the recommendation level is provided for the use software related to the use software information acquired in the process of S112, from the website management DB 146 (step S113). Specifically, the recommendation level acquisition unit 112 uses the website management table to acquire website information (URL) of the recommendation level information site corresponding to the use software information acquired in S112.

The recommendation level acquisition unit 112 acquires (extracts) a recommendation level (software recommendation level) of the use software shown in the use software information acquired in S112, from the recommendation level information server 30 corresponding to the website information acquired in S113 (step S114). Specifically, the recommendation level acquisition unit 112 accesses the website of the URL acquired in S113 to acquire the recommendation level (software recommendation level) of the use software. Then, the recommendation level acquisition unit 112 registers the software recommendation level acquired in the process of S114 in the recommendation level management DB 148 (step S115). Thus, the items of “software name”, “recommendation level information site”, and “recommendation level” in the website-specific recommendation level table illustrated in FIG. 8 are generated.

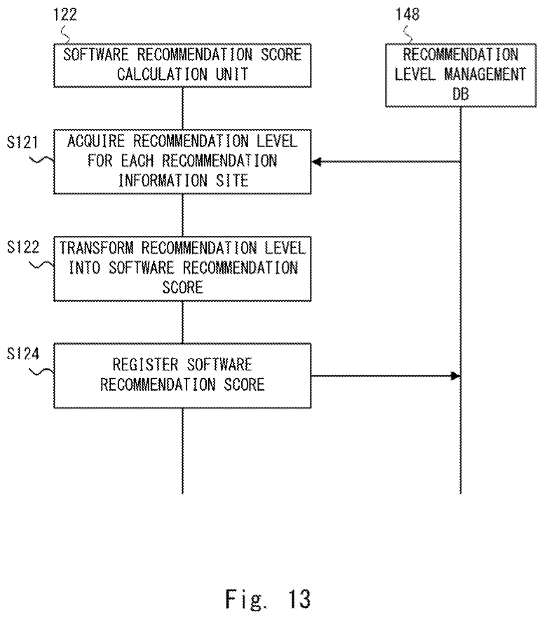

FIG. 13 is a sequence diagram showing details of the process of S120 shown in FIG. 11. The software recommendation score calculation unit 122 acquires a recommendation level for each recommendation level information site, from the recommendation level management DB 148 (step S121). For example, the software recommendation score calculation unit 122 acquires the “high activity” in the “site A” and the “recommendation” in the “site B” as recommendation levels of “OSS_A” from the website-specific recommendation level table illustrated in FIG. 8. The software recommendation score calculation unit 122 transforms the recommendation level in each recommendation level information site into a software recommendation score (step S122). Details will be described below. Then, the software recommendation score calculation unit 122 registers the software recommendation score calculated in the process of S122 in the recommendation level management DB 148 (step S124). Thus, the item of “software recommendation score” in the website-specific recommendation level table illustrated in FIG. 8 is generated.

Here, a specific example of the process of S122 will be described. As described above, the scoring method (evaluation index) of the recommendation level differs depending on each recommendation level information site. In other words, the recommendation level published on the recommendation level information site is not a common evaluation index. For example, in the example of FIG. 8, the recommendation level of “OSS_A” is “high activity” at the “site A”, and is “recommendation” at the “site B”. In this way, the evaluation index of the software is not unified in the recommendation level for each recommendation level information site. For this reason, in such a state, the software cannot be evaluated using the recommendation level for each of the plurality of recommendation level information sites. Therefore, in order to unify the evaluation index of the software, the software recommendation score calculation unit 122 transforms the recommendation level in each of the recommendation level information sites into a quantitative software recommendation score which is a common evaluation index.

The transformation from the recommendation level in each of the recommendation level information sites into the software recommendation score is performed using the recommendation level posted on the recommendation level information site and the last updated day of the recommendation level information site. Specifically, the above-described transformation is performed in such a manner that the recommendation level in each of the recommendation level information sites is remapped to the software recommendation score of 0 to 10 points and a weight corresponding to the last updated day is given to the remapped value.

For example, when the recommendation level information site is Open hub, remapping may be performed as follows, for example. Here, the recommendation level in Open hub is indicated by “ ”, and the corresponding software recommendation score (remapped value) is indicated by ( ).

For example, “very high activity” (10 points), “high activity” (8 points), “moderate activity” (6 points), “low activity” (3 points), “very low activity” (1 point), and “inactive” (0 point)

In the above example, for example, when the recommendation level in Open hub is “very high activity”, the corresponding software recommendation score (remapped value) is 10 points.

Further, when the recommendation level information site is Radar scope, remapping may be performed as follows, for example. Here, the recommendation level in Radar scope is indicated by “ ”, and the corresponding software recommendation score (remapped value) is indicated by ( ).

For example, “1 to 1.4” (1 point), “1.5 to 1.9” (2 points), “2 to 2.4” (3 points), “2.5 to 2.9” (4 points), “3 to 3.4” (6 points), “3.5 to 3.9” (8 points), “4 to 4.4” (9 points), and “4.5 to 5” (10 points)

In the above example, for example, when the recommendation level in Radar scope is 4.5 to 5, the corresponding software recommendation score (remapped value) is 10 points.

In addition, when the recommendation level information site is an OSS recommendation site in the organization, remapping may be performed as follows, for example. Here, the recommendation level information site is the OSS recommendation site in the organization is indicated by “ ”, and the corresponding software recommendation score is indicated by ( ).

For example, “recommendation” (9 points), “non-recommendation” (1 point), and “high risk” (0 point)

Further, an example of the weight corresponding to the last updated day is indicated below. Here, a period from the present to the last updated day is indicated by “ ”.

For example, “within 1 month”: 1, “1 to 2 months”: 0.9, “3 to 4 months”: 0.6, and “4 months or longer”: 0

In the above example, the shorter the period from the present to the last updated day, the larger the weight, and the longer the period from the present to the last updated day, and the smaller the weight. This is due to the idea that old information has low reliability and is not emphasized in calculating the software recommendation score.

In the above example, for example, in Open hub for a certain software “OSS_A”, the recommendation level indicates “high activity”, and the period from the present to the last updated day is “1 to 2 months”. Further, in Radar scope for “OSS_A”, the recommendation level indicates “4 to 4.4”, and the period from the present to the last updated day is “3 to 4 months”. In this case, the software recommendation score calculation unit 122 calculates the software recommendation score after weight in Open hub for “OSS_A” as 7.2 (=8×0.9). In this case, the software recommendation score calculation unit 122 calculates the software recommendation score after weight in Radar scope for “OSS_A” as 5.4 (=9×0.6).

Then, the software recommendation score calculation unit 122 may calculate a software evaluation score, which is an evaluation index of the software, by averaging the (weighted) software recommendation scores calculated for each recommendation level information site. For example, in the above example, the software evaluation score of “OSS_A” is 6.3 (=(7.2+5.4)/2). The software evaluation score may be calculated by a weighted average by a weight according to which recommendation level information site is emphasized.

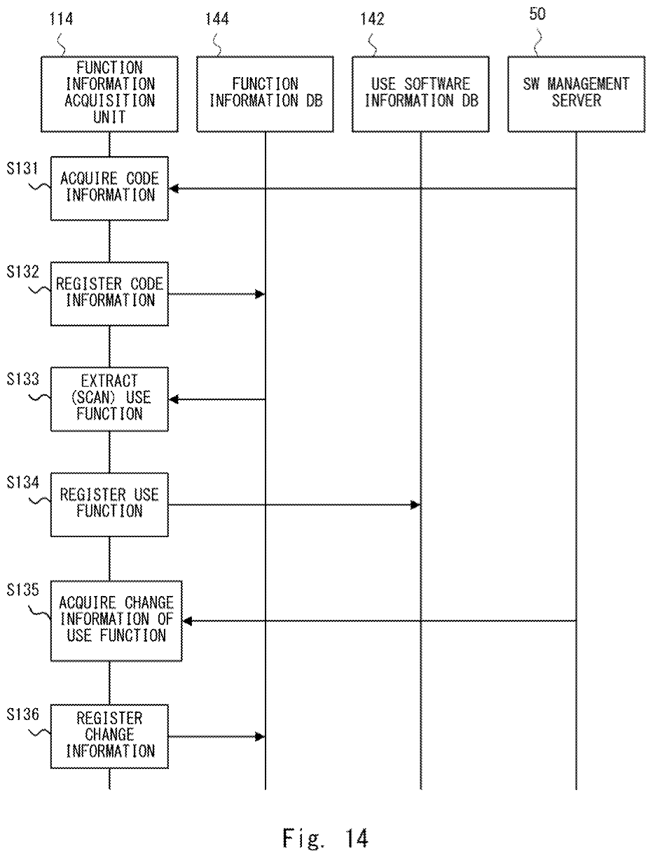

FIG. 14 is a sequence diagram showing details of the process of S130 shown in FIG. 11. The function information acquisition unit 114 acquires code information related to the use software from the software management server 50 (step S131). Specifically, a plurality of source files (source codes) constituting software such as OSS are registered in the software management server 50 such as GitHub. Therefore, the function information acquisition unit 114 uses a command for acquiring (extracting) the source files to acquire the source file (source code) related to the use software as code information. For example, a command such as “git clone” is used in GitHub, and thus the code information (source file) can be acquired. Then, the function information acquisition unit 114 registers the code information acquired in S131 in the function information DB 144 (step S132). The code information acquired in S131 and registered in S132 may include functions other than the use function, that is, functions (source codes) that are not used in the application to be developed in the use software function.

The function information acquisition unit 114 extracts (scans) the use function from the code information registered in S132 (step S133). Specifically, the function information acquisition unit 114 compares the code in the application to be developed with the code information registered in the function information DB 144 in S132. Thus, the function information acquisition unit 114 detects the use function (source file; source code) used in the application to be developed, from the code information registered in the function information DB 144.

In the example illustrated in FIG. 5, for example, it is assumed that “OSS_A” is configured by source files corresponding to “OSS_A function A”, “OSS_A function B”, and “OSS_A function C”. In this case, in S132, the source files corresponding to “OSS_A function A”, “OSS_A function B”, and “OSS_A function C” are registered in the function information DB 144. Then, the function information acquisition unit 114 detects, as use functions, “OSS_A function A” and “OSS_A function B” used in the application in the use software “OSS_A”.

Regarding a method of detecting the use function, for example, the function information acquisition unit 114 detects (searches for) a file name of the source file used in the application to be developed, from the code information registered in the function information DB 144 in S132. Further, the function information acquisition unit 114 detects (searches for) a character string matching the source code in the application to be developed, from the source code in the code information registered in the function information DB 144 in S132. Thus, the function information acquisition unit 114 can extract the source code used in the application to be developed.

Then, the function information acquisition unit 114 registers the use function (source file) extracted in S133 in the use software information DB 142 (step S134). Thus, the item of “use function” in the use software information table illustrated in FIG. 5 is generated.

The function information acquisition unit 114 acquires change information of the use function (source file) from the software management server 50 (step S135). In the example of FIG. 5, the function information acquisition unit 114 acquires change information corresponding to the source files of “OSS_A function A” and “OSS_A function B”. Then, the function information acquisition unit 114 registers the change information acquired in S135 in the function information DB 144 (step S136). Thus, the items of “code information” and “change information” of the function information table illustrated in FIG. 6 are generated.

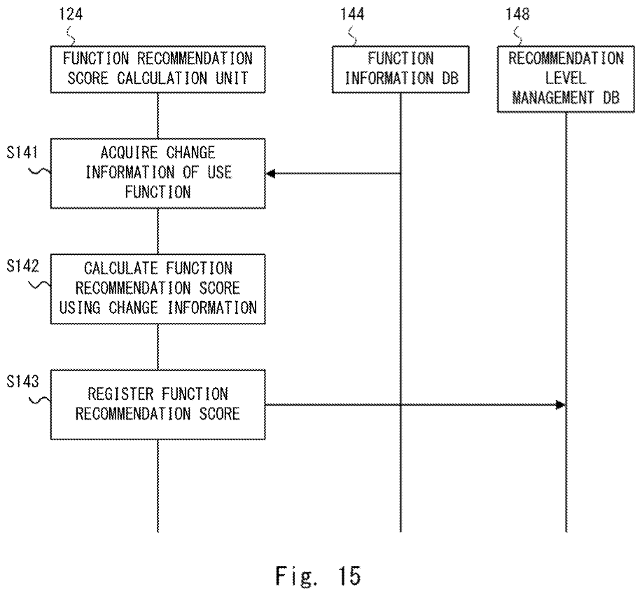

FIG. 15 is a sequence diagram showing details of the process of S140 shown in FIG. 11. The function recommendation score calculation unit 124 acquires change information of the use function (use source file) from the function information DB 144 (step S141). The function recommendation score calculation unit 124 calculates a function recommendation score using the change information (step S142). For example, for the source file having a high possibility of containing a bug (high bug-containing ratio), the function recommendation score calculation unit 124 may calculate the function recommendation score to be low, assuming that the reliability is low.

Regarding the bug-containing ratio, for example, source files whose bugs have been frequently and intensively modified in recent days may have a high bug-containing ratio. For example, the bug-containing ratio can be calculated by a bug prediction algorithm such as bugspots. The function recommendation score calculation unit 124 calculates a bug-containing ratio Score for each of the plurality of use functions (use source files) by, for example, Equation 1 below.

$$\begin{matrix}[ Formula 1 ] & \\ Score = {\sum }_{i = 0}^{n} \frac{1}{1 + {e}^{12 n + 12}} & ( 1 )\end{matrix}$$

In Equation 1, a symbol n is the number of times (number of commits) of the bug to be modified. Further, a symbol ti is a time stamp at the time of modification. Symbols n and ti are obtained from the change information.

The function recommendation score calculation unit 124 normalizes the Score for the use function (use source file) to a value of 0 to 1 by, for example, using a normalization function represented by Equation 2 below.

$$\begin{matrix}[ Formula 2 ] & \\ N ( x ) = \frac{x - xmin}{xman - xmin} & ( 2 )\end{matrix}$$

In Equation 2, x indicates the Score. Further, xmax indicates the maximum Score among Scores calculated for each of the plurality of use functions. Further, xmin indicates the minimum Score among Scores calculated for each of the plurality of use functions. Then, the function recommendation score calculation unit 124 uses Equation 3 below to calculate the function recommendation score for each of the use functions.

Function recommendation score=(1−N(x))*10 (3)

Then, the function recommendation score calculation unit 124 registers the function recommendation score in S142 in the recommendation level management DB 148 (step S143). Thus, the item of “function recommendation score” in the function-specific recommendation level table illustrated in FIG. 9 is generated. A method of normalizing the bug-containing ratio Score is not limited to the method of using Equation 2 above. For example, the remapping used in the software recommendation score described above may be used, or a monotonously increasing function f(Score) of 0 or more and 1 or less may be used.

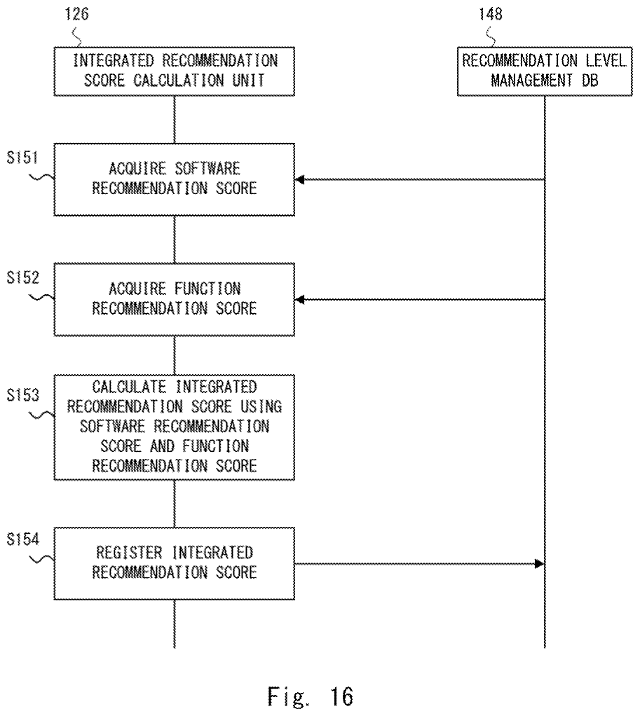

FIG. 16 is a sequence diagram showing details of the process of S150 shown in FIG. 11. The integrated recommendation score calculation unit 126 acquires a software recommendation score for the software to be evaluated, from the recommendation level management DB 148 (step S151). Specifically, the integrated recommendation score calculation unit 126 acquires (extracts) the software recommendation score for each website for the software to be evaluated, from the website-specific recommendation level table illustrated in FIG. 8. Further, the integrated recommendation score calculation unit 126 acquires a function recommendation score for the software to be evaluated, from the recommendation level management DB 148 (step S152). Specifically, the integrated recommendation score calculation unit 126 acquires (extracts) the function recommendation score for each use function, from the function-specific recommendation level table illustrated in FIG. 9.

Next, the integrated recommendation score calculation unit 126 calculates an integrated recommendation score using the software recommendation score and the function recommendation score (step S153). Specifically, the integrated recommendation score calculation unit 126 calculates the software evaluation score by averaging the software recommendation scores calculated for each of the recommendation level information sites. Further, the integrated recommendation score calculation unit 126 calculates the function evaluation score, which is an evaluation index of the function of the software, by averaging the function recommendation scores calculated for each use function. The function evaluation score may be calculated by a weighted average according to the number of lines of each use function (source file). For example, in the application to be developed, when the number of lines of a use function A is 1000 L and the number of lines of a use function B is 100 L, a weight of the use function A may be higher than a weight of the use function B.

The integrated recommendation score calculation unit 126 calculates an integrated recommendation score by a weighted average of the software evaluation score and the function evaluation score. Specifically, a weight is set in advance for each of the software evaluation score and the function evaluation score. Such a weight indicates an index (ratio) indicating which of the software evaluation score and the function evaluation score is emphasized, and how much each of them is emphasized. For example, when the weight of the software evaluation score is 4 and the weight of the function evaluation score is 1, the software evaluation score is given four times more emphasis than the function evaluation score.

Assuming that a weight of a software evaluation score Ss is defined as Ws and a weight of a function evaluation score Sf is defined as Wf, the integrated recommendation score calculation unit 126 calculates an integrated recommendation score Si using Equation 4 below.

$$\begin{matrix}[ Formula 3 ] & \\ Si = \frac{( Ss \times Ws ) + ( Sf \times Wf )}{Ws + Wf} & ( 4 )\end{matrix}$$

Then, the integrated recommendation score calculation unit 126 registers the calculated integrated recommendation score in the recommendation level management DB 148 (step S154). Thus, the item of the integrated recommendation score in the integrated recommendation level management table illustrated in FIG. 10 is generated. Further, the recommendation level management DB 148 registers the date on which the integrated recommendation score is registered. Then, the integrated recommendation score calculation unit 126 calculates the integrated recommendation score for any use software periodically or at an arbitrary timing. Thus, the recommendation level management DB 148 stores time-series data of the integrated recommendation score. For example, the recommendation level management DB 148 stores time-series data of the integrated recommendation score calculated every month.

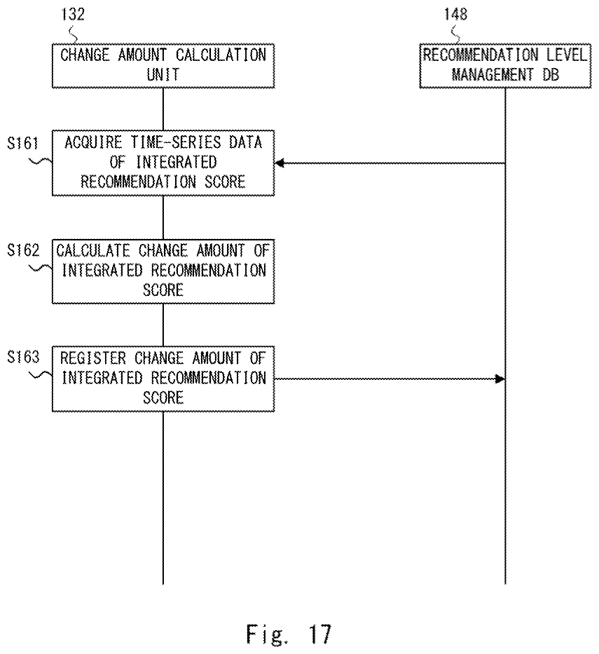

FIG. 17 is a sequence diagram showing details of the process of S160 shown in FIG. 11. The change amount calculation unit 132 acquires the time-series data of the integrated recommendation score from the recommendation level management DB 148 (step S161). Specifically, the change amount calculation unit 132 acquires the time-series data of the integrated recommendation score from the integrated recommendation level management table illustrated in FIG. 10. Then, the change amount calculation unit 132 calculates the change amount of the integrated recommendation score using the time-series data of the integrated recommendation score (step S162).

Here, the timing at which the integrated recommendation score is calculated is expressed as a k-th period (k is an integer of 1 or more). A first period is a timing at which the integrated recommendation score is first calculated. Further, a a-th period is a timing at which the integrated recommendation score is last calculated. At this time, the change amount calculation unit 132 may calculate, as the change amount, a difference between the integrated recommendation score calculated last and the integrated recommendation score calculated at the first period. Here, in order to analyze the tendency of the integrated recommendation score in the subsequent process (S170), it is preferable to smooth a transition of the change. Therefore, the change amount calculation unit 132 calculates a moving average value using the integrated recommendation score for the latest n periods, and may calculate, as the change amount, a difference between the moving average value and the integrated recommendation score for the first period.

An interval of the time-series data used at the time of calculation of the moving average value is set to 3 (n=3). At this time, the change amount calculation unit 132 calculates a moving average value(a) of the integrated recommendation score at the a-th period, using Equation 5 below.

Moving average value(a)=(Integrated recommendation score at a-th period+Integrated recommendation score at (a−1)-th period+Integrated recommendation score at (a−2)-th period)/3 (5)

Then, the change amount calculation unit 132 calculates a change amount(a) of the integrated recommendation score at the a-th period, using Equation 6 below.

Change amount(a)=Moving average value(a)−Integrated recommendation score at first period (6)

Then, the change amount calculation unit 132 registers the change amount of the integrated recommendation score in the recommendation level management DB 148 (step S163). Thus, the item of the change amount in the integrated recommendation level management table illustrated in FIG. 10 is generated. Then, the change amount calculation unit 132 calculates the change amount for any use software periodically or at an arbitrary timing. Thus, the recommendation level management DB 148 stores time-series data of the integrated recommendation score and the change amount.

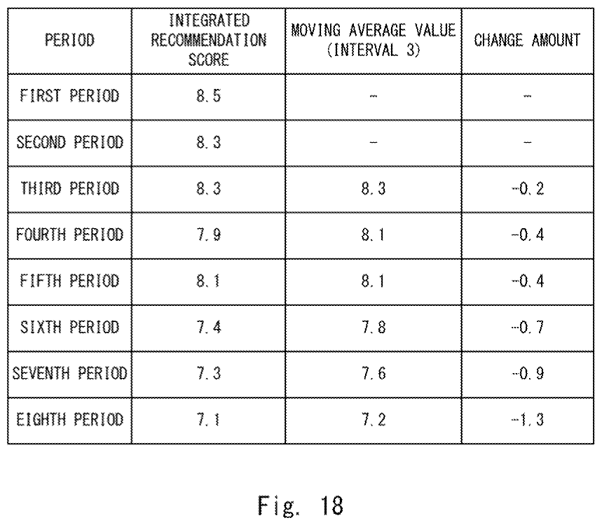

FIG. 18 is a diagram illustrating a transition in the moving average value and the change amount of the integrated recommendation score according to the first example embodiment. FIG. 18 illustrates the moving average value and the change amount of the integrated recommendation score from the first period to the eighth period. In the data shown in FIG. 18, rounding off to the first decimal place is made. In the example shown in FIG. 18, the change amount is a negative value at all timings after the third period. Further, an absolute value of the change amount is gradually increasing. Therefore, it can be seen that the integrated recommendation score (software recommended value) tends to be decreased.

An allowable value may be set in advance to consider a slight increase or decrease as an error, and when the absolute value of the change amount is within the allowable value, the change amount may be regarded as 0, that is, no tendency of change. For example, it is assumed that the allowable value is set to 0.5. In this case, the change amount between the first period and the third period is −0.2, and the absolute value of the change amount is within the allowable value. Therefore, a condition of change amount (3)=0 may be set.

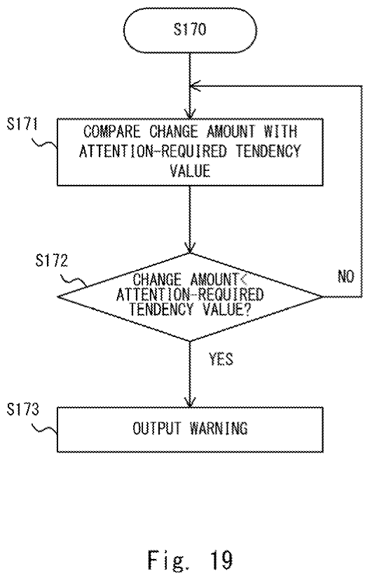

FIG. 19 is a flowchart showing details of the process of S170 shown in FIG. 11. The tendency determination unit 134 compares the change amount of the integrated recommendation score (software recommended value) with an attention-required tendency value (step S171). Here, the attention-required tendency value can be set in advance as a threshold value used to consider that the integrated recommendation score (software recommended value) continues to decrease and the software to be analyzed has a high tendency of a non-recommendation (attention-required tendency) in the future.

For example, a difference between a threshold value Th of the integrated recommendation score at which the software is determined to be a non-recommendation and the integrated recommendation score at the first period is multiplied by a preset coefficient c (c is a value of 0 or more and 1 or less), and thus the attention-required tendency value may be calculated. In the example shown in FIG. 18, when Th=3 and c=0.5, the attention-required tendency value is −2.7 (rounded off to the first decimal place) (=(3−8.5)×0.5).

The tendency determination unit 134 outputs a warning (step S173) when the change amount in the integrated recommendation score (software recommended value) is less than the attention-required tendency value (step S172). Specifically, the tendency determination unit 134 uses the interface unit 108 to output a warning that a risk related to the use software may occur. Thus, the user can recognize that a risk may occur in the use software.

### (Modification)

The present invention is not limited to the above example embodiment, and can be appropriately modified without departing from the gist. For example, the order of the processing in the flowchart and the sequence diagram shown in FIG. 11 and the like can be changed as appropriate. Further, one or more of the processes in the flowchart and the sequence diagram shown in FIG. 11 and the like may not be necessary. For example, in FIG. 11, the process of S120 and the processes of S130 and S140 may be opposite to each other.

Further, only one of the processes of S120 and S140 may be performed. In this case, the process of S150 may not be necessary. Then, the recommendation score calculated in either of the process of S120 and the process of S140 may be used as the software recommended value to perform the processes of S160 and S170. On the other hand, the tendency analysis is performed using the integrated recommendation score obtained by integration of the software recommendation score and the function recommendation score, and thus it is possible to analyze the tendency related to the use software more accurately as described above.

In the above-described example, the program may be stored and supplied to a computer using various types of non-transitory computer readable media. The non-transitory computer readable media include various types of tangible storage media. Examples of the non-transitory computer readable media include a magnetic recording medium (for example, a flexible disk, and a magnetic tape, and a hard disk drive), a magneto-optic recording medium (for example, a magneto-optic disk). Further, examples of the non-transitory computer readable media include a CD-ROM (Read Only Memory), a CD-R, and a CD-R/W. Further, examples of the non-transitory computer readable media include a semiconductor memory. Examples of the semiconductor memory include a mask ROM, a PROM (Programmable ROM), an EPROM (Erasable PROM), a flash ROM, and a RAM (Random Access Memory). These programs may be supplied to computers using various types of transitory computer readable media. Examples of the transitory computer readable media include an electrical signal, an optical signal, and an electromagnetic wave. The transitory computer readable media can supply programs to a computer through a wired communication line, for example, electric wires and optical fibers, or a wireless communication line.

Although the present invention is described above with reference to the example embodiment, the present invention is not limited to the above-described example embodiments. Various modifications that can be understood by those skilled in the art can be made to the configuration and details of the present invention within the scope of the present invention.

Some or all of the above-described example embodiments may also be described as in the following supplementary notes, but are not limited to the following.

### (Supplementary Note 1)

A software evaluation apparatus comprising:

information acquisition means for acquiring software information that is information related to software used in an application, the software enabling a plurality of users to view, use, and modify a source code;

recommended value calculation means for calculating, from the software information, a software recommended value which is a degree of reliability related to the software; and

tendency analysis means for analyzing a tendency related to the software based on a change in the software recommended value.

### (Supplementary Note 2)

The software evaluation apparatus according to Supplementary Note 1, wherein

the information acquisition means acquires, as the software information, function information related to a function of the software, and

the recommended value calculation means calculates, based on the function information, a function recommendation score which is an evaluation index related to the function of the software used in the application, and calculates the software recommended value using the function recommendation score.

### (Supplementary Note 3)

The software evaluation apparatus according to Supplementary Note 1 or 2, wherein

the information acquisition means acquires, as the software information, one or more recommendation levels for the software, and

the recommended value calculation means calculates, based on the one or more recommendation levels, a software recommendation score which is an evaluation index of the software, and calculates the software recommended value using at least the software recommendation score.

### (Supplementary Note 4)

The software evaluation apparatus according to Supplementary Note 2, wherein

the information acquisition means acquires, as the software information, one or more recommendation levels for the software, and

the recommended value calculation means calculates, based on the one or more recommendation levels, a software recommendation score which is an evaluation index of the software, and calculates the software recommended value using the software recommendation score and the function recommendation score.

### (Supplementary Note 5)

The software evaluation apparatus according to Supplementary Note 4, wherein

the recommended value calculation means calculates, as the software recommended value, an integrated recommendation score in which the software recommendation score and the function recommendation score are integrated, and

the tendency analysis means analyzes a tendency related to the software based on a change in the integrated recommendation score.

### (Supplementary Note 6)

The software evaluation apparatus according to any one of Supplementary Notes 1 to 5, wherein the tendency analysis means analyzes a tendency of the presence or absence of a risk occurrence related to the software, based on the change in the software recommended value and reference information indicating a reference for the change.

### (Supplementary Note 7)

The software evaluation apparatus according to Supplementary Note 6, wherein

the reference information is set in advance as a threshold value for a change amount of the software recommended value indicating that the software has a high tendency to be a non-recommendation, and

the tendency analysis means outputs a warning that there is a possibility of an occurrence of a risk related to the software when the change amount of the software recommended value falls below the threshold value.

### (Supplementary Note 8)

The software evaluation apparatus according to any one of Supplementary Notes 1 to 7, wherein the software is open source software.

### (Supplementary Note 9)

A software evaluation method comprising:

acquiring software information that is information related to software used in an application, the software enabling a plurality of users to view, use, and modify a source code;

calculating, from the software information, a software recommended value which is a degree of reliability related to the software; and

analyzing a tendency related to the software based on a change in the software recommended value.

### (Supplementary Note 10)

The software evaluation method according to Supplementary Note 9, further comprising:

acquiring, as the software information, function information related to a function of the software; and

calculating, based on the function information, a function recommendation score which is an evaluation index related to the function of the software used in the application, and calculating the software recommended value using the function recommendation score.

### (Supplementary Note 11)

The software evaluation method according to Supplementary Note 9 or 10, further comprising:

acquiring, as the software information, one or more recommendation levels for the software; and

calculating, based on the one or more recommendation levels, a software recommendation score which is an evaluation index of the software, and calculating the software recommended value using at least the software recommendation score.

### (Supplementary Note 12)

The software evaluation method according to Supplementary Note 10, further comprising:

acquiring, as the software information, one or more recommendation levels for the software; and

calculating, based on the one or more recommendation levels, a software recommendation score which is an evaluation index of the software, and calculating the software recommended value using the software recommendation score and the function recommendation score.

### (Supplementary Note 13)

The software evaluation method according to Supplementary Note 12, further comprising:

calculating, as the software recommended value, an integrated recommendation score in which the software recommendation score and the function recommendation score are integrated; and

analyzing a tendency related to the software based on a change in the integrated recommendation score.

### (Supplementary Note 14)

The software evaluation method according to any one of Supplementary Notes 9 to 13, further comprising analyzing a tendency of the presence or absence of a risk occurrence related to the software, based on the change in the software recommended value and reference information indicating a reference for the change.

### (Supplementary Note 15)

The software evaluation method according to Supplementary Note 14, wherein

the reference information is set in advance as a threshold value for a change amount of the software recommended value indicating that the software has a high tendency to be a non-recommendation, and

the software evaluation method further comprises outputting a warning that there is a possibility of an occurrence of a risk related to the software when the change amount of the software recommended value falls below the threshold value.

### (Supplementary Note 16)

The software evaluation method according to any one of Supplementary Notes 9 to 15, wherein the software is open source software.

### (Supplementary Note 17)

A non-transitory computer-readable medium storing a program that causes a computer to execute:

a step of acquiring software information that is information related to software used in an application, the software enabling a plurality of users to view, use, and modify a source code;

a step of calculating, from the software information, a software recommended value which is a degree of reliability related to the software; and

a step of analyzing a tendency related to the software based on a change in the software recommended value.

### REFERENCE SIGNS LIST

1 SOFTWARE EVALUATION APPARATUS
2 INFORMATION ACQUISITION UNIT
4 RECOMMENDED VALUE CALCULATION UNIT
6 TENDENCY ANALYSIS UNIT
20 SOFTWARE EVALUATION SYSTEM
22 NETWORK
30 RECOMMENDATION LEVEL INFORMATION SERVER
50 SOFTWARE MANAGEMENT SERVER
100 SOFTWARE EVALUATION APPARATUS
110 INFORMATION ACQUISITION UNIT
112 RECOMMENDATION LEVEL ACQUISITION UNIT
114 FUNCTION INFORMATION ACQUISITION UNIT
120 RECOMMENDED VALUE CALCULATION UNIT
122 SOFTWARE RECOMMENDATION SCORE CALCULATION UNIT
124 FUNCTION RECOMMENDATION SCORE CALCULATION UNIT
126 INTEGRATED RECOMMENDATION SCORE CALCULATION UNIT
130 TENDENCY ANALYSIS UNIT
132 CHANGE AMOUNT CALCULATION UNIT
134 TENDENCY DETERMINATION UNIT
142 USE SOFTWARE INFORMATION DB
144 FUNCTION INFORMATION DB
146 WEBSITE MANAGEMENT DB
148 RECOMMENDATION LEVEL MANAGEMENT DB

What is claimed is:

1. A software evaluation apparatus comprising:
hardware, including a processor and memory;
information acquisition unit implemented at least by the hardware and configured to acquire software information that is information related to software used in an application, the software enabling a plurality of users to view, use, and modify a source code;
recommended value calculation unit implemented at least by the hardware and configured to calculate, from the software information, a software recommended value which is a degree of reliability related to the software; and
tendency analysis unit implemented at least by the hardware and configured to analyze a tendency related to the software based on a change in the software recommended value.

2. The software evaluation apparatus according to claim 1, wherein
the information acquisition unit acquires, as the software information, function information related to a function of the software, and
the recommended value calculation unit calculates, based on the function information, a function recommendation score which is an evaluation index related to the function of the software used in the application, and calculates the software recommended value using the function recommendation score.

3. The software evaluation apparatus according to claim 1, wherein
the information acquisition unit acquires, as the software information, one or more recommendation levels for the software, and
the recommended value calculation unit calculates, based on the one or more recommendation levels, a software recommendation score which is an evaluation index of the software, and calculates the software recommended value using at least the software recommendation score.

4. The software evaluation apparatus according to claim 2, wherein
the information acquisition unit acquires, as the software information, one or more recommendation levels for the software, and
the recommended value calculation unit calculates, based on the one or more recommendation levels, a software recommendation score which is an evaluation index of the software, and calculates the software recommended value using the software recommendation score and the function recommendation score.

5. The software evaluation apparatus according to claim 4, wherein
the recommended value calculation unit calculates, as the software recommended value, an integrated recommendation score in which the software recommendation score and the function recommendation score are integrated, and
the tendency analysis unit analyzes a tendency related to the software based on a change in the integrated recommendation score.

6. The software evaluation apparatus according to claim 1, wherein the tendency analysis unit analyzes a tendency of the presence or absence of a risk occurrence related to the software, based on the change in the software recommended value and reference information indicating a reference for the change.

7. The software evaluation apparatus according to claim 6, wherein
the reference information is set in advance as a threshold value for a change amount of the software recommended value indicating that the software has a high tendency to be a non-recommendation, and
the tendency analysis unit outputs a warning that there is a possibility of an occurrence of a risk related to the software when the change amount of the software recommended value falls below the threshold value.

8. The software evaluation apparatus according to claim 1, wherein the software is open source software.

9. A software evaluation method comprising:
acquiring software information that is information related to software used in an application, the software enabling a plurality of users to view, use, and modify a source code;
calculating, from the software information, a software recommended value which is a degree of reliability related to the software; and
analyzing a tendency related to the software based on a change in the software recommended value.

10. The software evaluation method according to claim 9, further comprising:
acquiring, as the software information, function information related to a function of the software; and
calculating, based on the function information, a function recommendation score which is an evaluation index related to the function of the software used in the application, and calculating the software recommended value using the function recommendation score.

11. The software evaluation method according to claim 9, further comprising:
acquiring, as the software information, one or more recommendation levels for the software; and
calculating, based on the one or more recommendation levels, a software recommendation score which is an evaluation index of the software, and calculating the software recommended value using at least the software recommendation score.

12. The software evaluation method according to claim 10, further comprising:
acquiring, as the software information, one or more recommendation levels for the software; and
calculating, based on the one or more recommendation levels, a software recommendation score which is an evaluation index of the software, and calculating the software recommended value using the software recommendation score and the function recommendation score.

13. The software evaluation method according to claim 12, further comprising:
calculating, as the software recommended value, an integrated recommendation score in which the software recommendation score and the function recommendation score are integrated; and
analyzing a tendency related to the software based on a change in the integrated recommendation score.

14. Teh software evaluation method according to claim 9, further comprising analyzing a tendency of the presence or absence of a risk occurrence related to the software, based on the change in the software recommended value and reference information indicating a reference for the change.

15. The software evaluation method according to claim 14, wherein
the reference information is set in advance as a threshold value for a change amount of the software recommended value indicating that the software has a high tendency to be a non-recommendation, and
the software evaluation method further comprises outputting a warning that there is a possibility of an occurrence of a risk related to the software when the change amount of the software recommended value falls below the threshold value.

16. The software evaluation method according to claim 9, wherein the software is open source software.

17. A non-transitory computer-readable medium storing a program that causes a computer to execute:
a step of acquiring software information that is information related to software used in an application, the software enabling a plurality of users to view, use, and modify a source code;
a step of calculating, from the software information, a software recommended value which is a degree of reliability related to the software; and
a step of analyzing a tendency related to the software based on a change in the software recommended value.
